(19) United States
(12) Patent Application Publication
(10) Pub. No.: US 2016/0195341 A1
(43) Pub. Date: Jul. 7, 2016

(54) FLAT HEAT EXCHANGE TUBE, AND HEAT CARRIER-HEATING DEVICE AND AIR CONDITIONER FOR VEHICLE USING SAME

(71) Applicant: MITSUBISHI HEAVY INDUSTRIES AUTOMOTIVE THERMAL SYSTEMS CO., LTD., Aichi (JP)

(72) Inventors: Satoshi KOMINAMI, Aichi (JP); Koji NAKADO, Aichi (JP)

(73) Assignee: MITSUBISHI HEAVY INDUSTRIES AUTOMOTIVE THERMAL SYSTEMS CO., LTD., Kiyosu-shi, Aichi (JP)

(21) Appl. No.: 14/908,496

(22) PCT Filed: Sep. 4, 2014
(86) PCT No.: PCT/JP2014/073401

§ 371 Date: Jan. 28, 2016

(30) Foreign Application Priority Data
Sep. 19, 2013 (JP) 2013-194224

(51) Int. Cl. F28F 1/40; F28D 1/04; B60H 1/22; F28F 1/02; B60H 1/00

(52) U.S. Cl. CPC F28F 1/40; F28F 1/02; B60H 1/00385; B60H 1/2218; F28D 1/04

(57) ABSTRACT

Provided are a flat heat exchange tube, a heat carrier-heating device, and an air conditioner for a vehicle by which it is possible to reduce thermal contact resistance and improve thermal conductivity. A flat heat exchange tube is provided with: a flat tube constituted of a pair of molded plates; and wavy inner fins that are inserted between the molded plates, tips protruding in one direction and tips protruding in another direction of the wavy inner fins being soldered to the inner surfaces of the pair of molded plates. The wavy inner fins are provided with expansion allowance portions in a wall surface between the tips allowing deformation in a direction by which the distance between the tips increases, the flat heat exchange tube being expandable through the expansion allowance portion in a state in which the tips between the pair of molded plates are soldered thereto.

### TECHNICAL FIELD

The present invention relates to a flat heat exchange tube that can be applied to heating of a heat carrier by a PTC heater, and a heat carrier-heating device and an air conditioner for a vehicle using the same.

### BACKGROUND ART

Heat carrier-heating devices equipped with positive temperature coefficient (PTC) heaters having PTC elements as the heating elements are used for heating a heat carrier to be the heat source for heating systems in air conditioners for vehicles such as electric vehicles or hybrid vehicles. As such a heat carrier-heating device, Patent Documents 1 and 2, for example, disclose a configuration in which a plurality of flat heat exchange tubes, forming paths through which heat carrier flows, are stacked with PTC heaters being in close contact therebetween, thereby heating the heat carrier flowing through the flat heat exchange tubes by heat from the PTC heater.

In Patent Documents 1 and 2, the seal between tank portions and close contact between the flat heat exchange tubes and the PTC heaters is ensured by a configuration in which a plurality of flat heat exchange tubes having tank portions formed integrally therewith, and a plurality of groups of PTC heaters are stacked while filling the area between the tank portions with a sealing agent, and the flat heat exchange tubes and PTC heaters are held by pressure against the bottom surface of a housing by a pressing member; or close contact between the flat heat exchange tubes and the PTC heaters is ensured by a configuration in which the tank portions of the plurality of flat heat exchange tubes are soldered together, the tubes are pressed to spread them outward and the PTC heaters are disposed therebetween, and the flat heat exchange tubes and the PTC heaters are held by pressure against the bottom surface of the housing by the pressing member.

Meanwhile, Patent Documents 3 and 4 disclose configurations of respective types of flat heat exchange tubes. Patent Document 3 discloses a configuration in which wavy inner fins are inserted between a pair of molded plates and soldered together, the wavy inner fins being arranged such that a protruding tip on one side and a protruding tip on another side are arranged continuously and alternately along the width direction of the fins, and arranged alternately in the length direction with a prescribed gap therebetween. Patent Document 4 discloses configurations such as one in which a pair of molded plates having many protrusions or beads of various shapes formed thereon are disposed opposite each other and soldered together, a configuration in which the wavy inner fins are inserted into the flat tubes and soldered, and a configuration in which the wavy inner fins are formed into many separate parts in the lengthwise direction and formed so as to be offset with respect to each other left and right.

### CITATION LIST

### Patent Literature

Patent Document 1: Japanese Unexamined Patent Application Publication No. 2012-214207A

Patent Document 2: Japanese Unexamined Patent Application Publication No. 2012-218557A

Patent Document 3: Japanese Examined Patent Application Publication No. H05-45336

Patent Document 4: Japanese Unexamined Patent Application Publication No. H07-227631A

### SUMMARY OF INVENTION

### Technical Problem

As described in Patent Documents 3 and 4, in the case of flat heat exchange tubes having a configuration in which inner fins are inserted and soldered therein or a configuration in which protrusions or beads are soldered therein, it is difficult to expand the tubes, and thus, in order to apply such a configuration to heat carrier-heating devices such as those disclosed in Patent Documents 1 and 2 and alternately stack the PTC heaters and the flat heat exchange tubes while ensuring close contact therebetween, there was a need to fix the PTC heaters and flat heat exchange tubes in place by external pressure after such stacking.

In such a case, providing sealing agent between the plurality of tank portions of the flat heat exchange tubes in order to prevent fluid leakage therebetween is necessary, and there remains the problem of reliability of the sealing agent and assemblability. On the other hand, while the problems associated with usage of the sealing agent are solved by soldering together the tank portions, a gap of a certain width needs to be secured when the PTC heater is insulated by an insulating sheet, and this presented the problem that there was a high degree of difficulty in accurately positioning the PTC heaters and putting the PTC heaters and flat heat exchange tubes in close contact with each other after alternately stacking them, without damaging the insulating sheets.

The present invention takes into account such a situation, and an object thereof is to provide a flat heat exchange tube, and a heat carrier-heating device and an air conditioner for a vehicle using the same by which it is possible to reduce thermal contact resistance and improve thermal conductivity, while having a configuration in which the flat heat exchange tube having wavy inner fins inserted and soldered therein are expandable tubes and close contact is ensured with PTC heaters and the like stacked therewith.

### Solution to Problem

In order to solve the above-mentioned problems, a flat heat exchange tube of the present invention, and a heat carrier-heating device and an air conditioner for a vehicle using the same adopt the following means.

A flat heat exchange tube according to a first aspect of the present invention comprises: a flat tube configured by soldering together an opposing pair of molded plates formed from sheet materials having inner surfaces clad in solder; and wavy inner fins inserted between the molded plates of the flat tube, the wavy inner fins each having a tip protruding in one direction that is soldered to the inner surface of one of the molded plates, and a tip protruding in another direction that is soldered to the inner surface of another of the molded plates. The wavy inner fins each include an expansion allowance portion on a wall surface between the tip protruding in the one direction and the tip protruding in the other direction, and the expansion allowance portions allow deformation in a direction by which a distance between the tips increases, the flat tube being expandable through the expansion allowance portion in a state in which the tips are soldered to the pair of molded plates.

According to the first aspect of the present invention, the wavy inner fin is inserted between the pair of molded plates constituting the flat tubes and having respective tips soldered to the inner surfaces of the molded plates, and the wall surface between the tip of the wavy inner fin protruding to one side and the tip protruding to the other side is provided with an expansion allowance portion that allows deformation in a direction by which the distance between the tips increases, with the flat tube being expandable through the expansion allowance portion with the respective tips being soldered to the pair of molded plates. Thus, the flat heat exchange tube is configured by inserting the wavy inner fin into the flat tube and soldering the respective tips of the wavy inner fin thereto, and by applying a desired pressure (including water pressure) into the flat tube, the wavy inner fin can be deformed through the expansion allowance portion in the direction by which the distance between the tips increases, thereby allowing the flat tube to be expanded in the thickness direction. Thus, the flat heat exchange tube can be applied to a heat exchange device while being in close contact with an object to which heat is to be transferred. By expanding the flat heat exchange tube to place it in close contact with the object to which heat is to be transferred, it is possible to reduce thermal contact resistance and improve thermal conductivity.

Also, in a flat heat exchange tube according to the first aspect, the expansion allowance portion is configured as stepwise bends formed in the wall surface between the tip protruding in the one direction and the tip protruding in the other direction.

According to the first aspect of the present invention, the expansion allowance portion has stepwise bends formed in the wall surface between the tip protruding in one direction and the tip protruding in the other direction, and thus, when expanding the tube, the pressure applied therein causes the bends to deform so as to be diagonally upright, allowing the distance between the tips to be increased. Thus, it is possible to expand the flat tubes with ease despite the fact that the wavy inner fins are soldered to the pair of molded plates.

Also, in a flat heat exchange tube according to the first aspect of the present invention, the expansion allowance portion may be a reverse-tapered surface that is tapered towards the respective tips, the reverse-tapered surface being formed of the wall surface between the tip protruding in the one direction and the tip protruding in the other direction.

According to the first aspect of the present invention, the expansion allowance portion has a surface that is reverse-tapered towards the tips formed in the wall surface between the tip protruding in one direction and the tip protruding in the other direction, and thus, when expanding the tube, the pressure applied therein causes the surface reverse-tapered towards the tips to deform so as to be vertically upright, allowing the distance between the tips to be increased. Thus, it is possible to expand the flat tubes with ease despite the fact that the wavy inner fins are soldered to the pair of molded plates.

Also, in a flat heat exchange tube according to the first aspect of the present invention, the expansion allowance portion may be configured such that the tip protruding in the one direction and the tip protruding in the other direction are arranged alternately and continuously in a width direction of the wavy inner fin, and alternately and at a prescribed interval in a length direction of the wavy inner fin, with slits being provided in the wall surface at a base portion of the tips.

According to the first aspect of the present invention, the expansion allowance portion is configured such that the tip protruding towards one side and the tip protruding towards the other side are arranged alternately and continuously in the width direction of the fins while being arranged at a prescribed interval in the length direction, and slits are provided in the wall surface towards the base portion of the tips. Thus, when expanding the tubes, the pressure applied therein causes the multiple tips arranged alternately in the width direction and length direction of the fins to deform in the vertical direction through the slits provided in the base portions, thereby allowing the distance between the tips to be increased. Thus, it is possible to expand the flat tubes with ease despite the fact that the wavy inner fins are soldered to the pair of molded plates.

Also, in any of the above-mentioned flat heat exchange tube according to the first aspect of the present invention, the pair of molded plates may include tube expansion allowance portions in vertical walls thereof from soldered portions of edges of the pair of molded plates, the tube expansion allowance portion allowing deformation in a direction by which a distance between flat surfaces of the molded plates increases.

According to the first aspect of the present invention, the pair of molded plates include a tube expansion allowance portion that allows deformation of the vertical walls from the soldered portion at the edge to be deformed in a direction by which the distance between the flat surfaces of the molded plates increases. Thus, when expanding the tube, by expanding the expansion allowance portion to increase the distance between the tips, it is possible to expand the wavy inner fin, and by simultaneously deforming the pair of molded plates in the direction by which the distance between the flat surfaces of the molded plates increases through the tube expansion allowance portion, it is possible to expand the flat tube itself in the thickness direction through the tube expansion allowance portion. Therefore, it is possible to increase the ease with which the flat tube in which the wavy inner fin is inserted is expanded.

Also, in a heat carrier-heating device according to a second aspect of the present invention, a plurality of groups of PTC heaters are layered alternately between a plurality of flat heat exchange tubes, a heat carrier flowing through the flat heat exchange tubes being heated by control of electricity flowing to the PTC heaters, and the flat heat exchange tubes are the flat heat exchange tubes according to any one of claims 1 to 5, the PTC heaters and the flat heat exchange tubes being in close contact with each other by the flat heat exchange tubes being expanded while the PTC heaters are layered alternately between the plurality of flat heat exchange tubes.

According to the second aspect of the present invention, in a heat carrier-heating device, a plurality of groups of PTC heaters are alternately layered between the plurality of flat heat exchange tubes, and the heat carrier flowing in the flat heat exchange tubes is heated by the PTC heaters. The flat heat exchange tubes are any of the above-mentioned flat heat exchange tubes, and by expanding the plurality of flat heat exchange tubes with the PTC heaters being layered alternately between flat heat exchange tubes, the PTC heaters are put in close contact with the flat heat exchange tubes, and thus, it is possible to put the alternately layered flat heat exchange tubes and PTC heaters in sufficiently close contact, and when heating the heat carrier flowing through the flat heat exchange tubes by the PTC heaters, it is possible to transfer the heat from the PTC heaters to the flat heat exchange tubes and heat the flat heat exchange tubes with lowered thermal contact resistance and efficiently transfer heat between the PTC heaters and the flat heat exchange tubes. Thus, it is possible to improve the heating capabilities of the PTC heaters and improve the performance of the heat carrier-heating device.

Also, an air conditioner for a vehicle according to a third aspect of the present invention is configured such that a heat carrier heated by a heat carrier-heating device can circulate to a heat radiator disposed in an airflow path, wherein the heat carrier-heating device is the above-mentioned heat carrier-heating device.

According to the third aspect of the present invention, the heat carrier heated by the heat carrier-heating device is circulated to the heat radiator disposed in the airflow path, and thus, the heat carrier supplied to the heat radiator disposed in the airflow path can be heated and supplied by the heat carrier-heating device having reduced thermal contact resistance and improved thermal conductivity between the PTC heaters and the flat heat exchange tubes, and therefore higher performance. Therefore, the air conditioning capabilities, and in particular, the heating capabilities of a hybrid or electric vehicle can be improved in the air conditioner for a vehicle.

### Advantageous Effects of Invention

The flat heat exchange tube of the present invention has a configuration in which the wavy inner fins are inserted in the flat tube and the respective tips thereof are soldered to the inside of the flat tubes, and a desired pressure (including water pressure) is applied in the flat tube to cause the wavy inner fins to deform so as to expand through the expansion allowance portion in a direction by which the distance between the tips increases. As a result, it is possible to expand the flat tube in the thickness direction thereof, and thus, it is possible to apply the flat heat exchange tubes to a device in which heat is exchanged by the flat heat exchange tubes being in close contact with the object to which heat is to be transmitted, thereby reducing thermal contact resistance and improving thermal conductivity.

According to the heat carrier-heating device of the present invention, it is possible to arrange the alternately layered flat heat exchange tubes and the PTC heaters so as to be in sufficient contact with each other, and when heating the heat carrier flowing through the flat heat exchange tubes by the PTC heaters, the heat emitted from the PTC heaters can be efficiently transmitted to the flat heat exchange tubes by reducing the thermal contact resistance between the PTC heaters and the flat heat exchange tubes. Thus, it is possible to improve the heating capability of the PTC heaters and improve the performance of the heat carrier-heating device.

In addition, according to the air conditioner for a vehicle of the present invention, it is possible to supply the heat carrier supplied to the heat radiators disposed in the airflow path from the heat carrier-heating device after being heated, the heat carrier-heating device being higher performance as a result of reduced thermal contact resistance and improved thermal conductivity between the PTC heaters and the flat heat exchange tubes. As a result, it is possible to improve the air conditioning capabilities of the air conditioner for a vehicle, and in particular, the heating capabilities of a hybrid or electric vehicle.

### BRIEF DESCRIPTION OF DRAWING(S)

FIG. 1 is an external perspective view of a heat carrier-heating device using flat heat exchange tubes according to a first embodiment of the present invention.

FIG. 2 is an exploded perspective view of the heat carrier-heating device illustrated in FIG. 1.

FIG. 3 is a vertical cross-sectional view of the heat carrier-heating device illustrated in FIG. 1.

FIG. 4 is a side view of a heat exchange element of the heat carrier-heating device illustrated in FIG. 1.

FIG. 5 is an exploded perspective view of the heat exchange element illustrated in FIG. 4.

FIG. 6 is an enlarged cross-sectional view of a protruding portion of heat carrier inlet/outlet pipes of the heat exchange element illustrated in FIG. 4.

FIG. 7 is a plan view of a flat heat exchange tube, a heat carrier inlet/outlet header, and the heat carrier inlet/outlet pipes of the heat exchange element illustrated in FIG. 4.

FIG. 8 is a side view of the flat heat exchange tube, the heat carrier inlet/outlet header, and the heat carrier inlet/outlet pipes illustrated in FIG. 7, along the lengthwise direction of the tube.

FIG. 9 is a left side view of the flat heat exchange tube, the heat carrier inlet/outlet header, and the heat carrier inlet/outlet pipes illustrated in FIG. 7.

FIG. 10 is an exploded perspective view of the heat carrier inlet/outlet header and the heat carrier inlet/outlet pipes illustrated in FIG. 7.

FIG. 11 is a plan view in which a portion of the flat heat exchange tube illustrated in FIG. 7 is cut away.

FIG. 12 is a cross-sectional view along the line A-A of the flat heat exchange tube illustrated in FIG. 11.

FIG. 13A is a partial enlarged cross-sectional view of the flat heat exchange tube illustrated in FIG. 12 prior to tube expansion.

FIG. 13B is a partial enlarged cross-sectional view of the flat heat exchange tube illustrated in FIG. 12 after tube expansion.

FIG. 14 is a partial cross-sectional view of a flat heat exchange tube according to a second embodiment of the present invention.

FIG. 15A is a partial perspective view of wavy inner fins for flat heat exchange tubes according to a third embodiment of the present invention.

FIG. 15B is an enlarged view of slits of the wavy inner fins for flat heat exchange tubes according to the third embodiment of the present invention.

### DESCRIPTION OF EMBODIMENTS

Embodiments of the present invention will be described below, referring to the attached drawings.

### First Embodiment

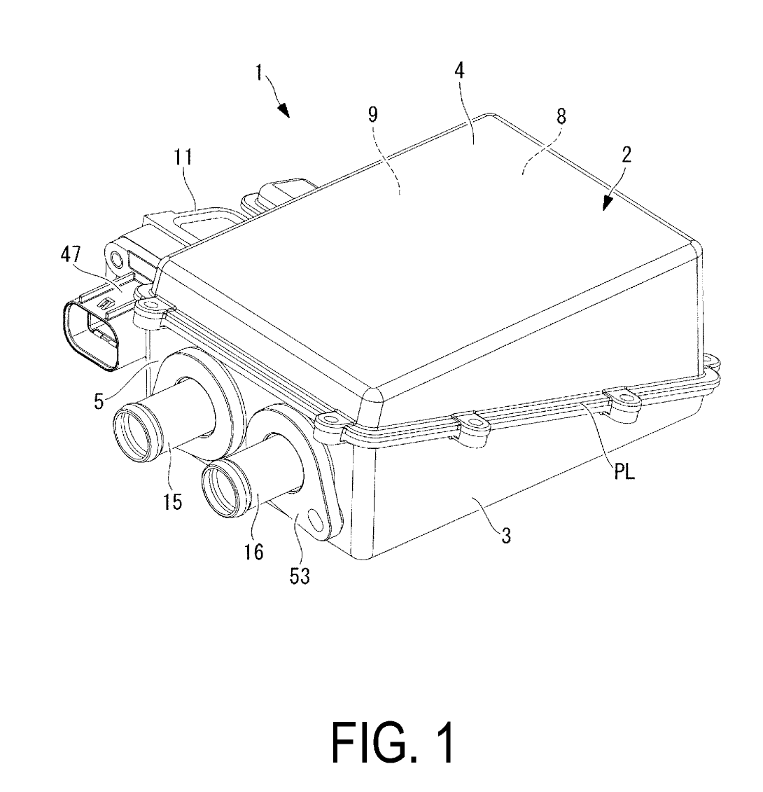

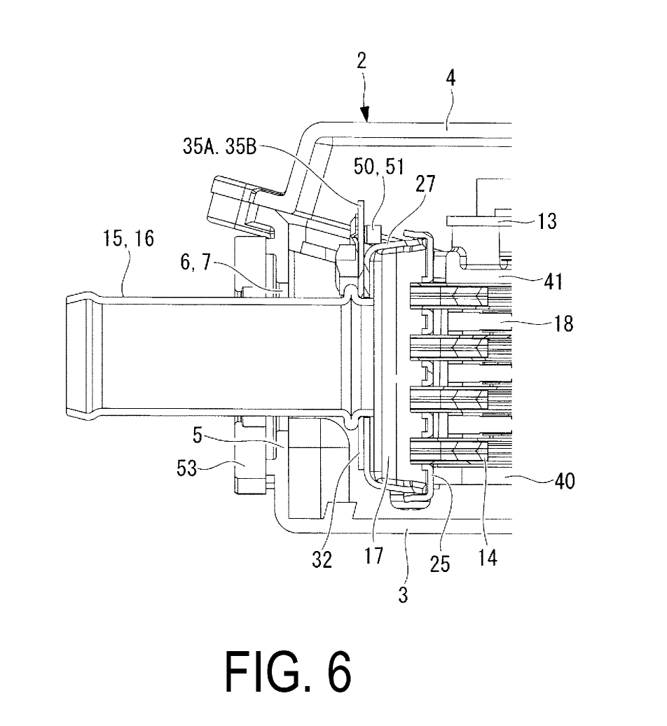

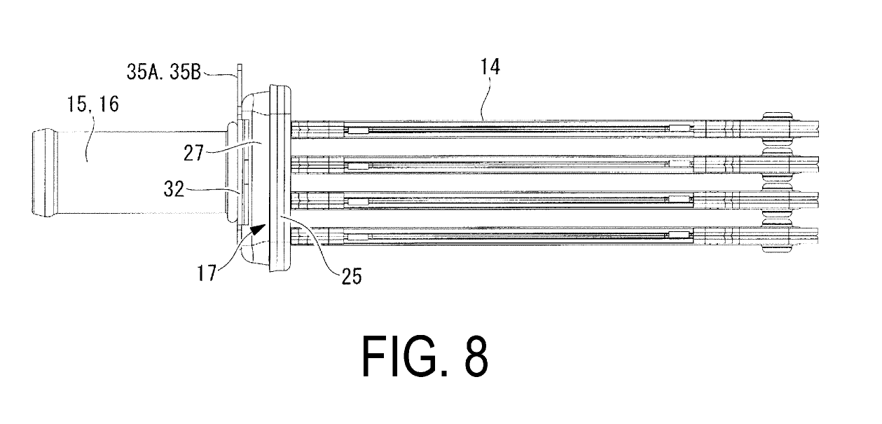

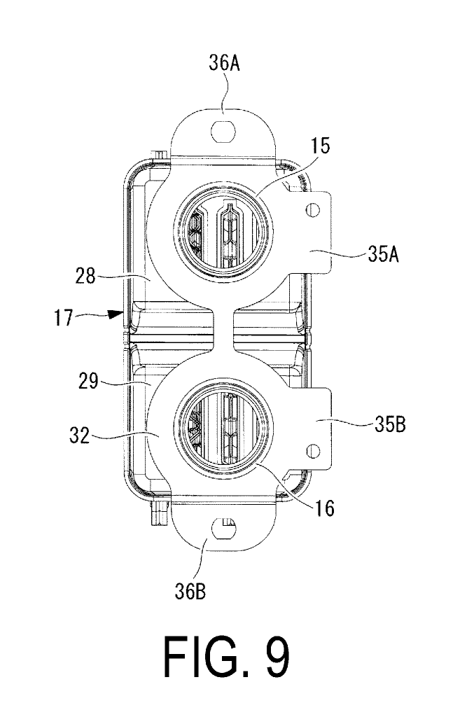

A first embodiment of the present invention will be described below, using FIG. 1 to FIG. 13B.

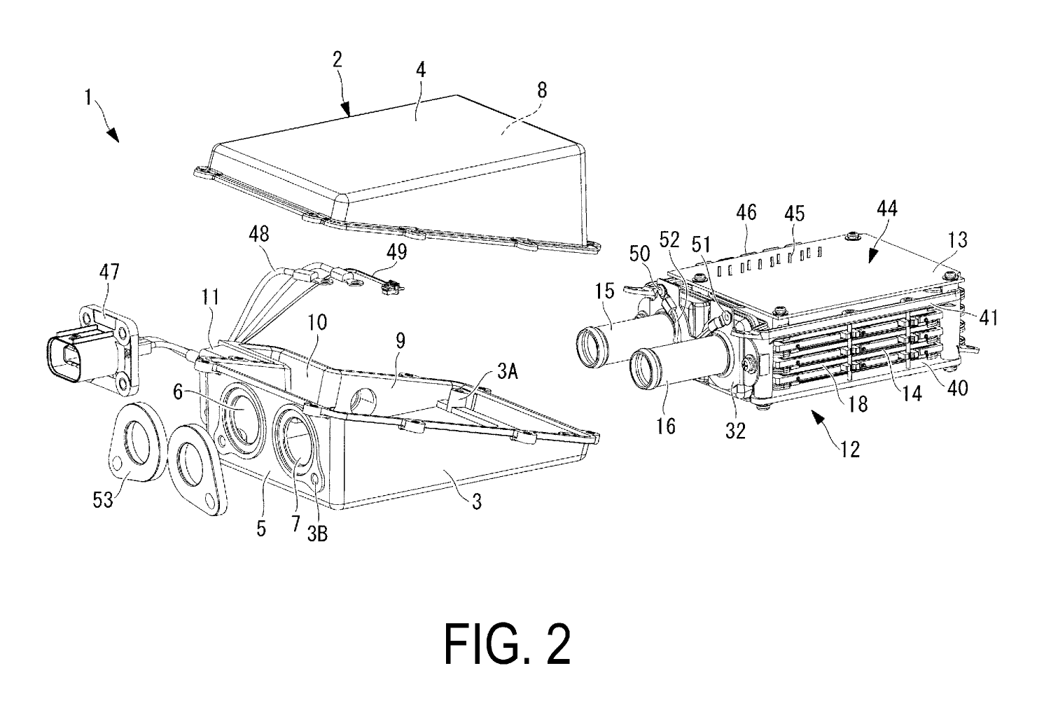

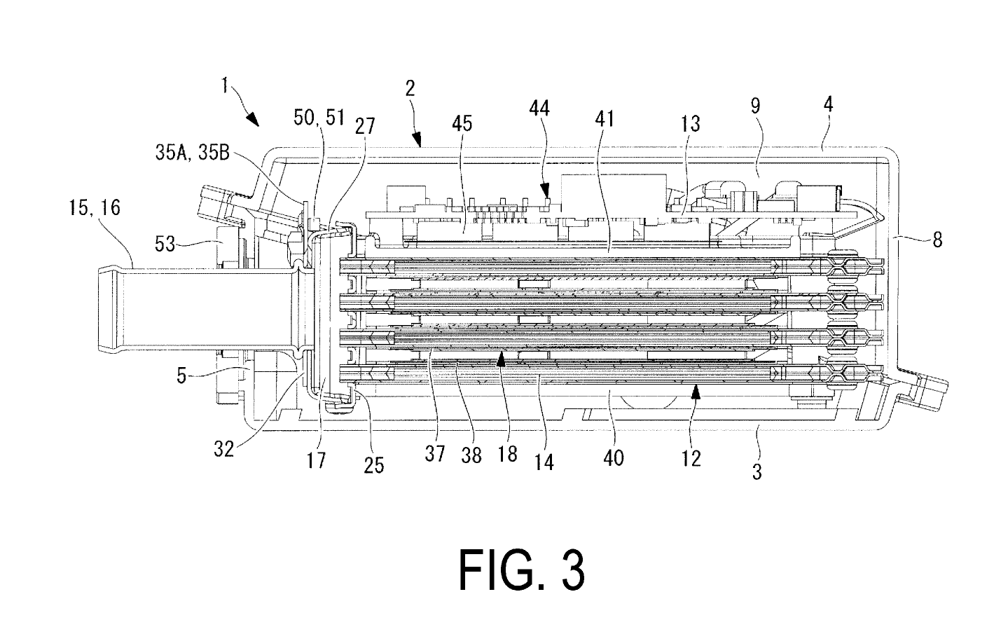

FIG. 1 is an external perspective view of a heat carrier-heating device using flat heat exchange tubes according to the first embodiment of the present invention, FIG. 2 is an exploded perspective view thereof, and FIG. 3 is a vertical cross-sectional view thereof.

The heat carrier-heating device 1 is for heating a heat carrier that is the heat source for a heating system in an air conditioner for a vehicle used in electric or hybrid vehicles or the like, and is configured such that the heat carrier circulates through a heat carrier pump between heat radiators of the air conditioner for a vehicle. The heat carrier-heating device 1 includes a box-shaped housing 2.

The box-shaped housing 2 has one side surface as a pipe-insertion surface 5 provided with insertion holes 6 and 7 through which heat carrier inlet/outlet pipes 15 and 16 (sometimes referred to simply as inlet/outlet pipes) are inserted while being sealed. The housing 2 is divided into a resin or aluminum alloy lower housing 3 and upper housing 4, which are divided from each other up and down along a diagonal parting line PL extending from the upper portion of the pipe-insertion surface 5 to the lower portion of an opposing surface 8. The upper housing 4 is fixed onto the lower housing 3 having interior parts assembled thereto by screws through a liquid gasket or the like, forming a sealed housing 2.

The other side surface 9 of the lower housing 3 is provided with a harness insertion portion 11 (insertion portion) provided with an insertion hole 10 through which an HV harness 48 and an LV harness 49 to be mentioned later are inserted. Also, the bottom surface of the lower housing 3 is provided with a plurality of boss parts 3A for fixing therein a heat exchange element 12 to be mentioned later by screws or the like, and the pipe-insertion surface 5 is provided with a plurality of boss parts 3B formed integrally therewith for fixing sealing members 53 or the like for sealing the insertion holes 6 and 7 after the heat carrier inlet/outlet pipes 15 and 16 are inserted through the insertion holes 6 and 7.

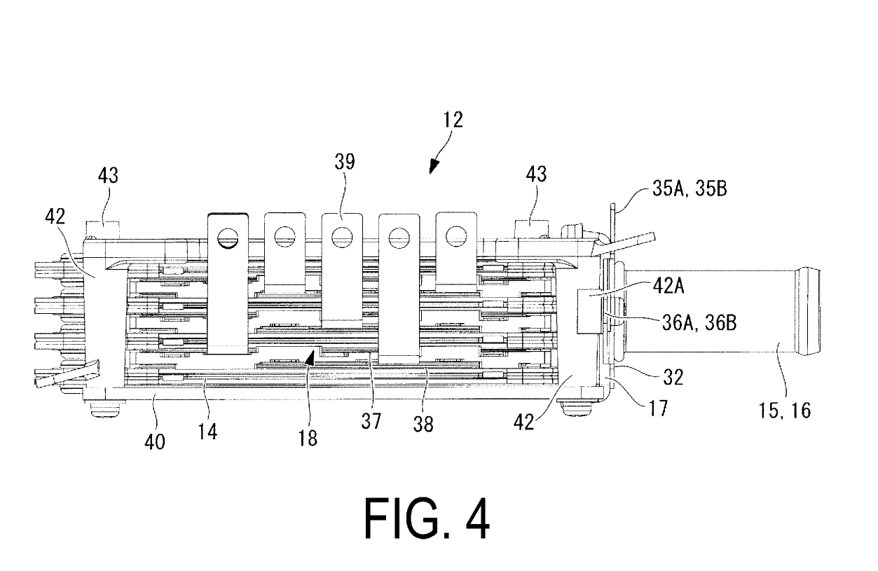

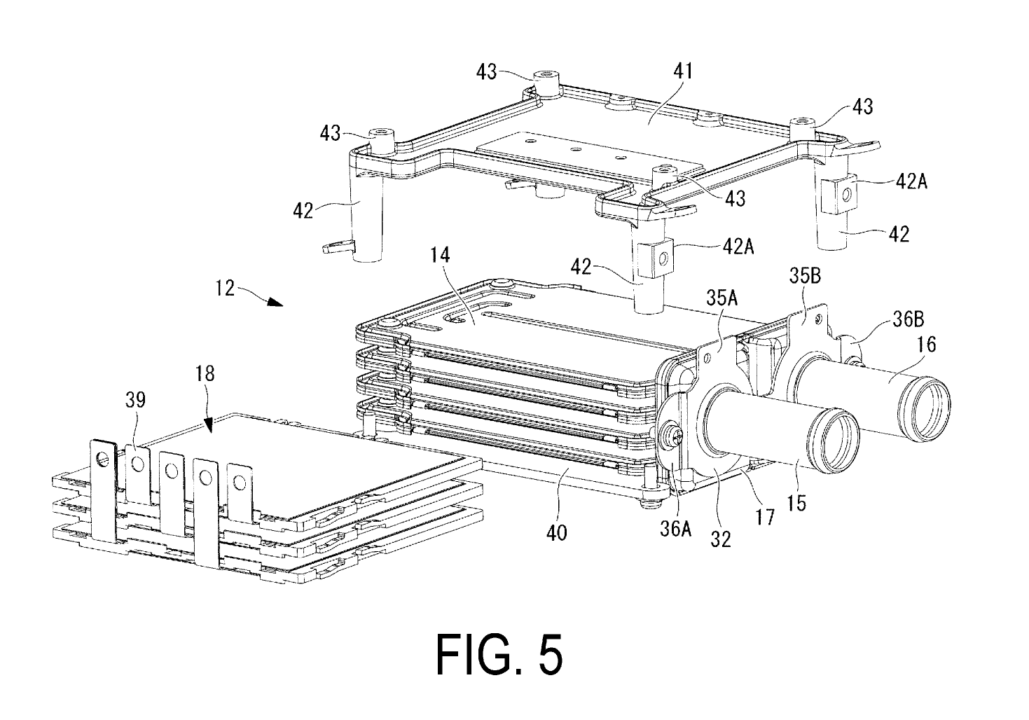

A heat exchange element 12 that exchanges heat with the heat carrier flowing through the inlet/outlet pipes 15 and 16 and heats the heat carrier, and a control board 13 that controls the power applied to PTC heaters 18 of the heat exchange element 12 are accommodated inside the housing 2. As illustrated in FIGS. 4 and 5, the heat exchange element 12 is constituted of: a plurality of (four in the present embodiment) flat heat exchange tubes 14; a heat carrier inlet/outlet header 17 to which the plurality of flat heat exchange tubes 14 are connected at a prescribed gap therebetween, the pair of heat carrier inlet/outlet pipes 15 and 16 being connected to the heat carrier inlet/outlet header 17, which was formed integrally by soldering; and a plurality of groups of PTC heaters 18 respectively disposed between the plurality of flat heat exchange tubes 14.

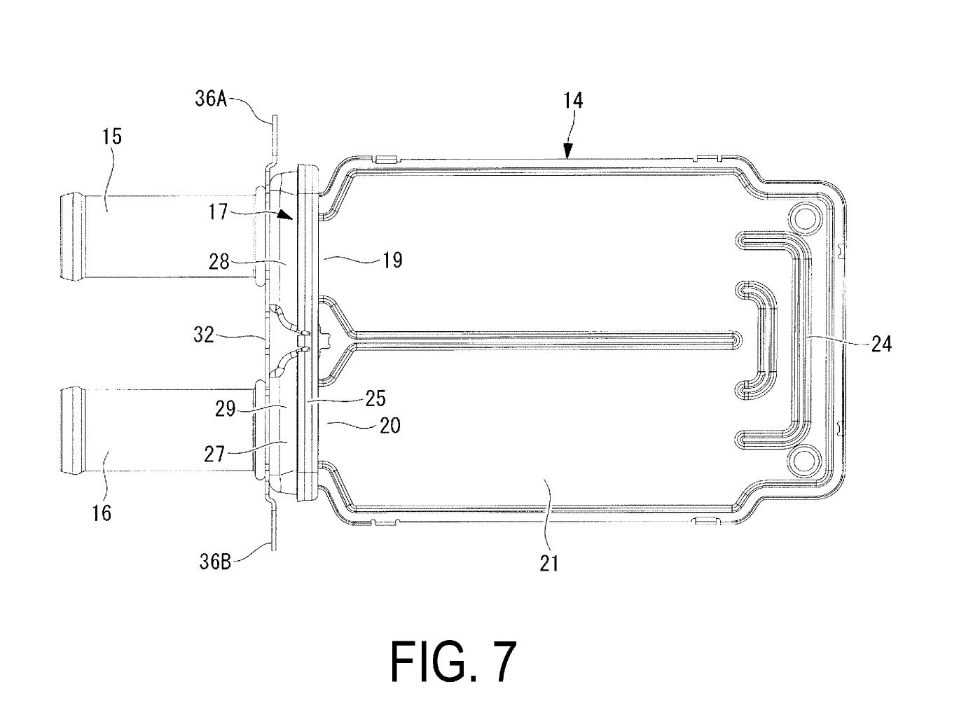

As illustrated in FIGS. 7 to 9, the heat exchange element 12 includes a plurality of (four in the present embodiment) flat heat exchange tubes 14 having formed therein a U-turn path 21 by which the heat carrier flowing from a heat carrier inlet 19 provided on one end turns back to a heat carrier outlet 20 provided on one end. The heat exchange element 12 is configured such that the four flat heat exchange tubes 14 are provided in four levels vertically at a prescribed interval therebetween, and the respective heat carrier inlets 19 and heat carrier outlets 20 thereof are soldered to the heat carrier inlet/outlet header 17, thereby integrating the flat heat exchange tubes 14 to the heat carrier inlet/outlet header 17.

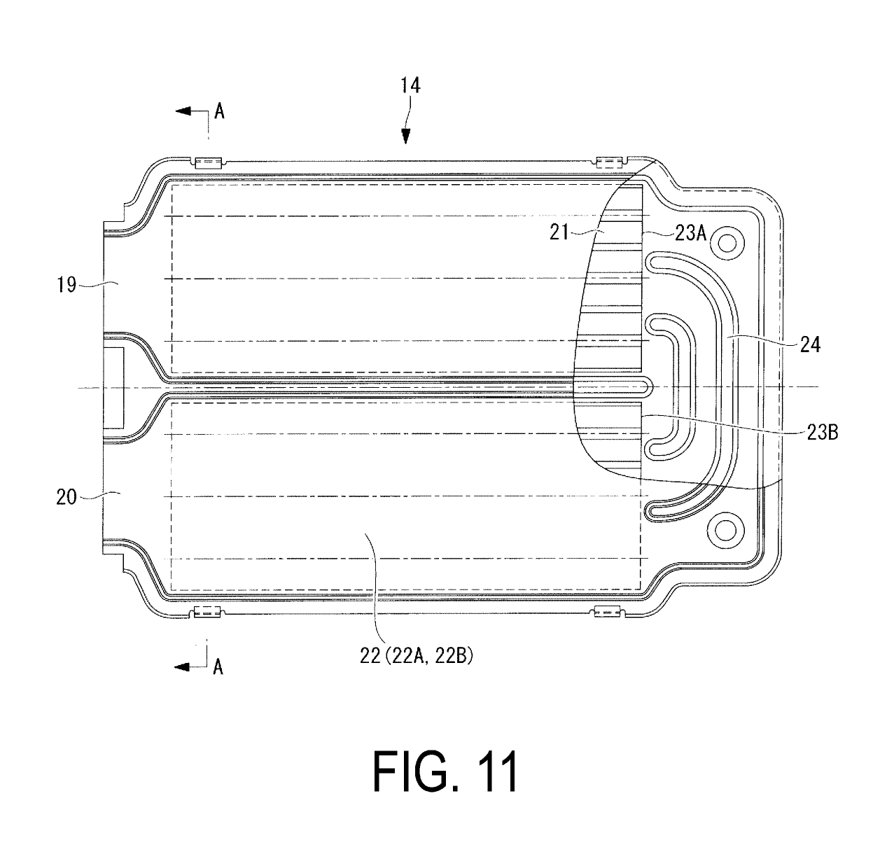

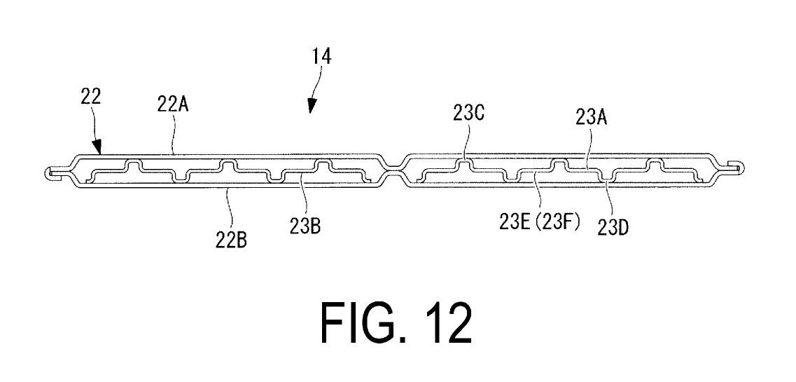

As illustrated in FIGS. 11 and 12, the flat heat exchange tubes 14 are constituted of flat tubes 22 formed by assembling together a pair of aluminum alloy molded plates 22A and 22B opposing each other in the vertical direction to form a hollow U-turn path 21, and by inserting into the straight line portions of the U-turn path 21 two wavy inner fins 23A and 23B having the same shape as each other and formed by molding thin aluminum alloy plates, the wavy inner fins 23A and 23B are integrally soldered therewith, and the U-turn portion of the U-turn path 21 has ribs 24 having a U-shape formed integrally therewith so as to penetrate from the inner surface side of the molded plates 22A and 22B.

The flat tubes 22 are formed by the pair of molded plates 22A and 22B, which are formed by molding clad materials that are clad by solder only on the inner surfaces, and the wavy inner fins 23A and 23B inserted therein are formed by molding a bare material. The wavy inner fins 23A and 23B have tips 23C protruding to one side soldered to the inner surface of one molded plate 22A and tips 23D protruding to the other side soldered to the inner surface of the other molded plate 22B, and are provided with expansion allowance portions 23E constituted of stepwise bends 23F, formed in the wall surface between the tips 23C and 23D, that allow deformation in a direction by which the distance between the two tips increases.

In this manner, the flat heat exchange tubes 14 have a configuration in which the wavy inner fins 23A and 23B are inserted into the flat tubes 22 with the respective tips 23C and 23D being soldered thereon, while being easily expandable by a desired pressure (including water pressure and the like) inside the flat tubes 22.

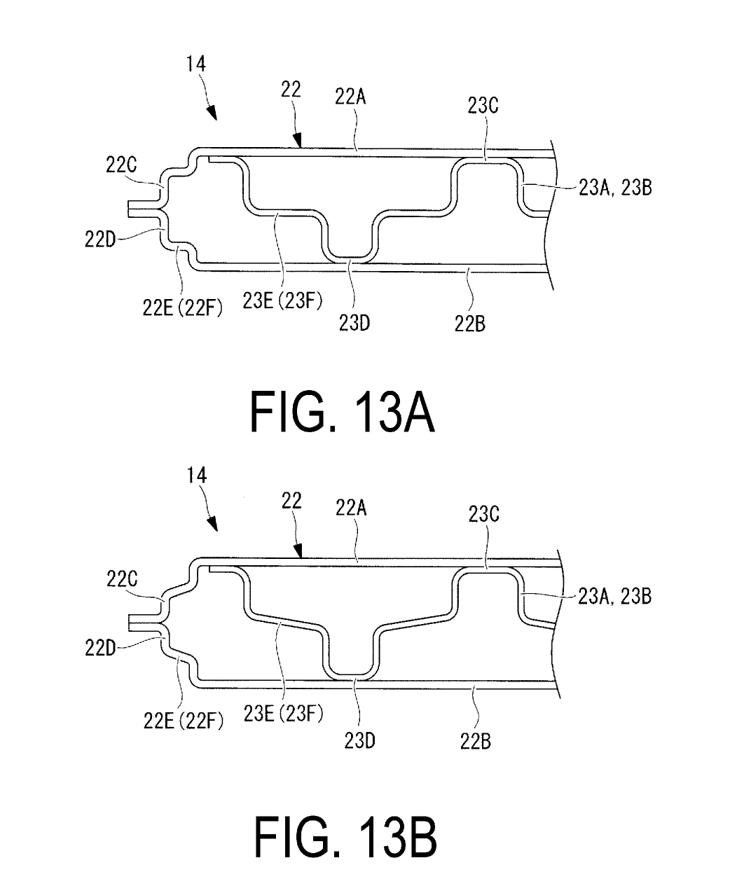

In order for the flat heat exchange tubes 14 to be easily expandable, a configuration as illustrated in FIGS. 13A and 13B may be adopted in which tube expansion allowance portions 22E, having stepwise bends 22F that allow deformation in a direction by which the distance between the flat surfaces of the molded plates 22A and 22B increases, are provided in vertical walls 22C and 22D formed from the soldered portions at the edges of the pair of molded plates 22A and 22B constituting the flat tubes 22.

The heat carrier inlet/outlet header 17 distributes the heat carrier flowing from the heat carrier inlet pipe 15 to the plurality of flat heat exchange tubes 14, and causes the flows of heat carrier heated by the PTC heaters 18 as they flow in the flat heat exchange tubes 14 to merge and exit the heat carrier outlet pipe 16, and as described above, the heat carrier inlet/outlet header 17 is formed integrally with the pair of heat carrier inlet/outlet pipes 15 and 16 and the plurality of flat heat exchange tubes 14 by being soldered therewith.

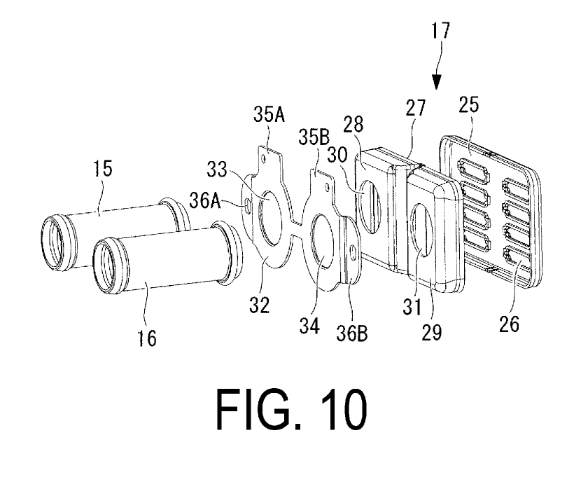

As illustrated in FIG. 10, the heat carrier inlet/outlet header 17 includes: a header plate 25 formed by molding an aluminum alloy plate having the outer surface thereof clad in solder; a header tank member 27 that is joined to the header plate 25 and is constituted of a pair of an inlet header tank portion 28 and an outlet header tank portion 29 separated by a partition, the inlet header tank portion 28 and the outlet header tank portion 29 being made of an aluminum alloy and clad in solder; and a pipe connection member 32 having a pair of connecting holes 33 and 34 that connect to the heat carrier inlet/outlet pipes 15 and 16, the pipe connection member 32 being made of an aluminum alloy and having an eyeglass shape that is joined to the outer surface of the header tank member 27, thereby being formed integrally therewith.

The header plate 25 is provided with two columns left and right and four levels of connecting holes 26 for inserting and connecting the heat carrier inlets 19 and the heat carrier outlets 20 of the plurality of (four) flat heat exchange tubes 14. The inlet header tank portion 28 of the header tank member 27 is provided with a heat carrier inlet 30 that is continuous with the heat carrier inlet pipe 15, and the outlet header tank portion 29 of the header tank member 27 is provided with a heat carrier outlet 31 that is continuous with the heat carrier outlet pipe 16. Additionally, the pipe connecting member 32 is provided with a pair of connecting holes 33 and 34, and has integrally formed therewith water temperature sensor installation pieces 35A and 35B extending upward from above the connecting holes 33 and 34, and flanges 36A and 36B to be screwed onto fixing portions 42A provided on legs 42 of a substrate platform 36 to be mentioned later.

The heat carrier inlet/outlet pipes 15 and 16 are cylindrical pipes of a prescribed length that each have one end respectively inserted into and soldered with the pair of connecting holes 33 and 34 provided in the pipe connecting member 32 towards the heat carrier inlet/outlet header 17, and into the heat carrier inlet 30 and heat carrier outlet 31 of the header tank member 27. The respective components of the flat heat exchange tubes 14, the respective components of the heat carrier inlet/outlet header 17, the flat heat exchange tube 14 and heat carrier inlet/outlet header 17, and the heat carrier inlet/outlet header 17 and heat carrier inlet/outlet pipes 15 and 16 are respectively soldered together. Such soldering is performed by first provisionally assembling the respective components as described above using a jig, and then simultaneously soldering all parts in a furnace.

As illustrated in FIGS. 7 to 9, the heat exchange element 12 is subassembled by assembling the PTC heaters 18 to the flat heat exchange tubes 14, the heat carrier inlet/outlet pipes 15 and 16, and the heat carrier inlet/outlet header 17, which have been integrated together. Publicly known PTC heaters 18 may be used, the PTC heaters 18 having a configuration in which the PTC element is sandwiched at the top and bottom surfaces thereof between two electrode plates 37 and 38. As illustrated in FIGS. 4 and 5, the PTC heaters 18 are inserted, with interposed insulating sheets (not illustrated), between the flat heat exchange tubes 14, which are provided at a prescribed interval therebetween, the PTC heaters 18 being positioned by a positioning pin or the like at prescribed positions between the flat heat exchange tubes 14.

Plate-shaped terminals 39 having a uniform width extend from the respective electrode plates 37 and 38 of the PTC heaters 18, and the terminals 39 are respectively bent and extend upward. The terminals 39 can be connected to a plurality of terminal platforms 46 disposed in parallel along one side of the bottom surface of the control board 13 to be mentioned later by being directly screwed thereto.

As illustrated in FIGS. 4 and 5, the heat exchange element 12 is assembled between a rectangular pressing board 40 disposed below the bottommost flat heat exchange tube 14, and an aluminum die-cast substrate platform 41 fixed to the pressing board 40 by the legs 42 having a prescribed length and provided at the four corners of the pressing board 40. With the upper and lower surfaces thereof fixed in place by a jig, water pressure or the like is applied inside the flat heat exchange tubes 14 to expand the flat heat exchange tubes 14, thereby causing the surfaces of the PTC heaters 18 and the flat heat exchange tubes 14 to be in close contact with each other.

The substrate platform 41 has a rectangular shape with substantially the same area as the pressing board 40, the flat heat exchange tube 14, and the control board 13, and has a configuration including the legs 42 of a prescribed length extending downward from the four corners of the substrate platform 41, with the top surface thereof having four boss parts 43 for fixing thereon the control board 13. The control board 13, which is fixed by screws or the like onto the boss parts 43 of the substrate platform 41, is equipped with a control circuit 44 that controls the power applied to the PTC heaters 18 (specific circuit not illustrated), and can be connected to the HV harness 48 and the LV harness 49 through a connector 47 fixed to the harness penetration portion 11 (penetration portion).

Also, the control board 13 has a configuration in which detection signals, from the intake and outtake side water temperature sensors 50 and 51 disposed on the water temperature sensor installation pieces 35A and 35B provided integrally with the pipe connecting member 32, are inputted through the harness 52. Additionally, the control board 13 has on the bottom surface thereof a plurality of power transistors 45 (only the terminals thereof are illustrated) such as insulated gate bipolar transistors (IGBTs) constituting the control circuit 44, and has along one side thereof a plurality of terminal platforms 46 that connect to the terminals 39 that extend from the electrode plates 37 and 38 of the PTC heater 18.

When the control board 13 is subassembled by being disposed on the substrate platform 41, the power transistors 45 such as IGBTs, which are heating components, are disposed so as to be in contact with the substrate platform 41 made of an aluminum alloy and disposed on the top surface of the flat heat exchange tubes 14, thereby allowing cooling with the substrate platform 41 as a heat sink, and the terminals 39 extending from the electrode plates 37 and 38 directly connect to the terminal platform 46 by screws or the like.

As illustrated in FIG. 2, the heat carrier-heating device 1 is configured such that the HV harness 48 and the LV harness 49 pass through the insertion hole 10 and the connector 47 thereof is screwed in place after coating the harness insertion portion 11 on the lower housing 3 with a liquid gasket, after which the heat exchange element 12 and the control board 13, which have been subassembled in advance, are assembled onto the lower housing 3, and the heat carrier inlet/outlet pipes 15 and 16 are inserted horizontally into the insertion holes 6 and 7 provided in the pipe-insertion surface 5. Then the heat exchange element 12 and control board 13 are fixed by screws or the like onto the plurality of boss parts 3A provided on the bottom surface of the lower housing 3.

The heat carrier inlet/outlet pipes 15 and 16 are inserted into the insertion holes 6 and 7 of the pipe-insertion surface 5 in a sealed state by inserting sealing members 53 such as grommets in the outer circumferential portions of the inlet/outlet pipes 15 and 16 from the outer edge side, and then fixing the sealing members 53 in place to the boss parts 3B using screws or the like, the heat carrier inlet/outlet pipes 15 and 16 sticking out of one side surface of the housing 2.

The subassembled heat exchange element 12 and control board 13 are assembled onto the lower housing 3 as described above, and then HV harness 48, the LV harness 49, and the harnesses 52 of the water temperature sensors 50 and 51 are respectively connected to the control board 13, thereby allowing the electrical system to be connected to the control board 13. Then, after connection is completed, the lower housing 3 is coated in a liquid gasket and fixed to the upper housing 4 by screws or the like, thereby closing the housing 2.

In the embodiment above, a configuration is described in which, when the control board 13 is subassembled onto the substrate platform 41, the terminals 39 extending from the electrode plates 37 and 38 are connected to the terminal platforms 46, but when connecting the harnesses to the control board 13, the terminals 39 may simultaneously be connected to the terminal platform 46. Also, in the embodiment above, the heat exchange element 12 having the PTC heaters 18 between the plurality of flat heat exchange tubes 14 is disposed between the pressing board 40 and the substrate platform 41, and in that state, the top and bottom surfaces are fixed in place with a jig and the flat heat exchange tubes 14 are expanded, causing the flat heat exchange tubes 14 and the PTC heaters 18 to be in close contact with each other, but the following configuration may instead be adopted.

In a state in which the subassembled heat exchange element 12 with the PTC heaters 18 inserted therein is directly assembled to the bottom surface of the lower housing 3 with the substrate platform 41 being fixed to the bottom surface of the lower housing 3, the control board 13 may be assembled onto the substrate platform 41 after water pressure or the like is applied inside the flat heat exchange tubes 14 to expand the respective flat heat exchange tubes 14 to cause the flat heat exchange tubes 14 to be in close contact with the PTC heaters 18, and similar effects to the above embodiment can be attained even with this configuration.

According to the configuration as described above, the present embodiment has the following action and effects.

The heat carrier, circulated in the heat carrier-heating device 1 through a pump flows from the inlet pipe 15 of the heat exchange element 12 into the inlet header tank portion 28 of the heat carrier inlet/outlet header 17, is distributed to the four flat heat exchange tubes 14, and then is heated as a result of heat being applied thereon by the PTC heaters 18 as the heat carrier flows in the U-turn path 21. The flows of heat carrier heated while flowing through the flat heat exchange tubes 14 merge at the outlet header tank portion 29 and are supplied to heat radiators through the outlet pipe 16, thereby being supplied to the heat source for a heating system.

The temperature of the heat carrier heated by the heat carrier-heating device 1 is adjusted to a set temperature by detecting the entering temperature and exit temperature of the heat carrier by the water temperature sensors 50 and 51 disposed in the water temperature sensor installation pieces 35A and 35B provided integrally with the pipe connecting member 32, which is joined to the heat carrier inlet/outlet header 17, and controlling the flow of electrical current to the PTC heaters 18 by the control board 13 on the basis of the detected temperatures.

In the heat carrier-heating device 1, the heat exchange element 12 constituted of the plurality of flat heat exchange tubes 14 and the PTC heaters 18 includes the plurality of flat heat exchange tube 14 having U-turn paths 21 formed therein, the heat carrier inlet/outlet header 17 having one end of the flat heat exchange tubes 14 soldered thereon and the heat carrier inlet/outlet pipes 15 and 16 connected thereto, and the plurality of groups of PTC heaters 18 layered alternately between the flat heat exchange tubes 14. The heat exchange element 12 is sandwiched between the pressing board 40 or the bottom surface of the lower housing 3 and the substrate platform 41, and the plurality of flat heat exchange tubes 14 and the plurality of groups of PTC heaters 18 are accommodated in the housing 2 in close contact with each other.

The flat heat exchange tubes 14 and the PTC heaters 18 are arranged such that the plurality of flat heat exchange tubes 14 are connected to the heat carrier inlet/outlet header 17 at a prescribed interval therebetween, and the PTC heaters 18 are inserted into the small gaps between the flat heat exchange tubes 14 (in a state in which the top and bottom surfaces are sandwiched between the electrode plates 37 and 38 and the insulating sheets are disposed between both surfaces). With the flat heat exchange tubes 14 and the PTC heaters 18 being pressed between the pressing board 40 and the substrate platform 41 and fixed to a jig, water pressure or the like is applied to the inside of the flat heat exchange tubes 14 to expand the flat heat exchange tubes 14 and put the flat heat exchange tubes 14 and the PTC heaters 18 into close contact with each other.

In this manner, it is possible to put the plurality of flat heat exchange tubes 14 and the plurality of groups of PTC heaters 18 having a layered structure in close contact with each other in the housing 2, and reduce the thermal contact resistance at the contact surfaces to ensure high heat-transfer efficiency. Thus, it is possible to provide a heat carrier-heating device 1 having a high degree of reliability, without the risk of heat carrier leakage, as a result of the soldered structure, the heat carrier-heating device 1 having high flexibility in where the inlet/outlet pipes 15 and 16 are present, and being high efficiency and high performance.

The plurality of flat heat exchange tubes 14 are each constituted of a flat tube 22 formed by soldering the opposing pair of molded plates 22A and 22B formed from sheet materials having inner surfaces clad in solder, and the wavy inner fins 23A and 23B having the same shape as each other and formed of bare sheet materials, which are inserted in the flat tube 22 and soldered therein. The wavy inner fins 23A and 23B have tips 23C protruding in one direction soldered to the inner surface of one molded plate 22A and tips 23D protruding in the other direction soldered to the inner surface of the other molded plate 22B.

Also, the wavy inner fins 23A and 23B are provided with expansion allowance portions 23E having stepwise bends 23F that allow deformation in a direction by which the distance between the tips 23C and 23D increases, each of the expansion allowance portions 23E being present on the wall surface between the tip 23C protruding towards one side and the tip 23D protruding towards the other side.

Thus, in the flat heat exchange tubes 14, the flat tubes 22 can be expanded in the thickness direction by applying a desired water pressure or the like to the inner portion thereof to cause the wavy inner fins 23A and 23B to deform in the direction by which the distance between the tips 23C and 23D increases through the expansion allowance portions 23E having the stepwise bends 23F.

By deforming the pair of molded plates 22A and 22B constituting the flat tube 22 in the direction by which the distance between the flat surfaces of the molded plates 22A and 22B increases through the tube expansion allowance portions 22E including the stepwise bends 22F, it is possible to expand the flat tube 22 itself in the thickness direction through the tube expansion allowance portion 22E. Therefore, it is possible to improve the ease with which the flat heat exchange tube 14 into which the wavy inner fins 23A and 23B are inserted is expanded.

Thus, even if a configuration is adopted in which the plurality of flat heat exchange tubes 14 are disposed at an even interval allowing insertion therebetween of the PTC heaters 18 including therebetween the electrode plates 37 and 38 and the insulating sheets (not illustrated), it is possible to put the plurality of flat heat exchange tubes 14 and the plurality of groups of PTC heaters 18 in close contact with each other by expanding the flat heat exchange tubes 14 in which the wavy inner fins 23A and 23B are inserted after layering the plurality of flat heat exchange tubes 14 alternately with the PTC heaters 18.

In other words, the flat heat exchange tubes 14 of the present embodiment have a configuration in which the wavy inner fins 23A and 23B are inserted into the flat tube 22 and the respective tips 23C and 23D thereof are soldered to the inside of the flat tubes 22, and a desired pressure (including water pressure or the like) is applied in the flat tube 22 to cause the wavy inner fins 23A and 23B to deform so as to expand through the expansion allowance portion 22E in a direction by which the distance between the tips 23C and 23D increases. As a result, it is possible to expand the flat tube 22 in the thickness direction thereof, and thus, it is possible to arrange the flat heat exchange tubes 14 to be in close contact with the PTC heaters 18 to which heat is transmitted, thereby reducing thermal contact resistance and improving thermal conductivity therebetween.

Also, in the heat carrier-heating device 1 in which the PTC heaters 18 are alternately layered between the high performance flat heat exchange tubes 14 into which the wavy inner fins 23A and 23B are inserted, by expanding the flat heat exchange tubes 14 while the PTC heaters 18 are layered alternately with the flat heat exchange tubes 14, it is possible to achieve sufficient contact between the PTC heaters 18 and the flat heat exchange tubes 14. Therefore, when heating the heat carrier by the PTC heaters 18, it is possible to reduce thermal contact resistance between the PTC heaters 18 and the flat heat exchange tubes 14 and transmit heat efficiently therebetween, thereby heating the heat carrier. As a result, it is possible to improve heating performance of the PTC heaters 18 and improve the performance of the heat carrier-heating device 1, as well as improve the ease of installation of the PTC heaters 18 between the flat heat exchange tubes 14, to improve assemblability.

Also, the flat heat exchange tubes 14 are constituted of the pair of molded plates 22A and 22B made of clad materials having inner surfaces clad in solder and outer surfaces with no solder cladding, and thus, it is possible to prevent damage by solder to the interposed insulating sheets when inserting the PTC heaters 18 between the flat heat exchange tubes 14, allowing improvements in quality and reliability in the heat carrier-heating device 1.

Furthermore, according to an air conditioner for a vehicle of the present embodiment, it is possible to provide a structure in which the heat carrier heated by the heat carrier-heating device 1 is cycled to a heat radiator disposed in the airflow path. Thus, it is possible to reduce thermal contact resistance and improve thermal conductivity between the PTC heaters 18 and the flat heat exchange tubes 14 and supply the heat carrier supplied to the heat radiators from the higher performance heat carrier-heating device 1 after being heated, and thus, it is possible to improve the air conditioning capabilities of the air conditioner for a vehicle, and in particular, the heating capabilities of a hybrid or electric vehicle.

### Second Embodiment

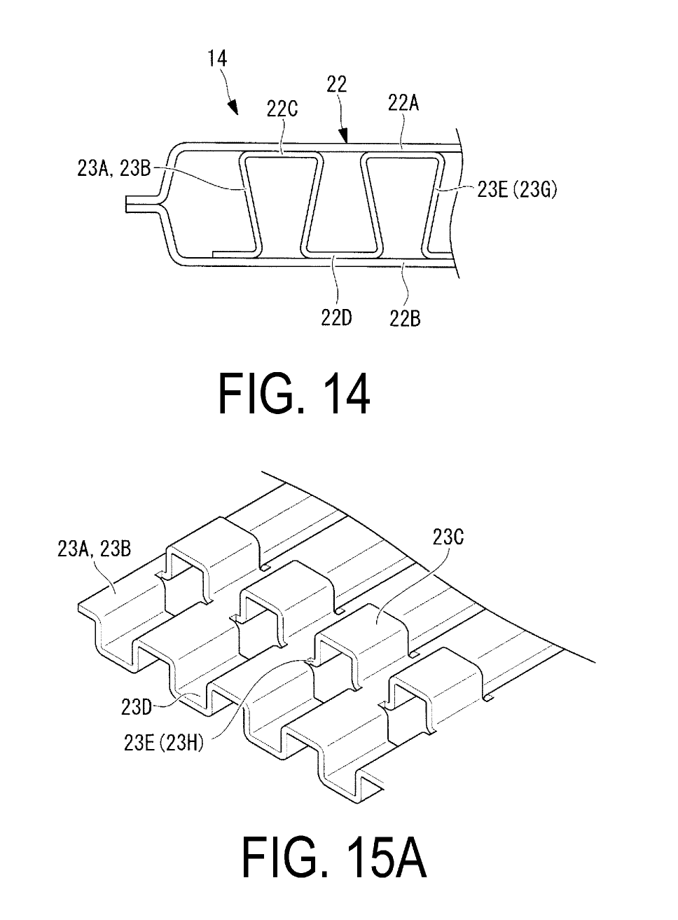

A second embodiment of the present invention will be described below, using FIG. 14.

The present embodiment differs from the first embodiment in terms of the configuration of the expansion allowance portion 23E provided in the wavy inner fins 23A and 23B. Other points are the similar to the first embodiment, so their descriptions are omitted here.

In the present embodiment, the expansion allowance portion 23E are formed by the wall surfaces between the tips 23C protruding in one direction and the tips 23D protruding in the other direction of the wavy inner fins 23A and 23B, and as illustrated in FIG. 14, the expansion allowance portion 23E has reverse tapered surfaces 23G tapered towards the tips 23C and 23D.

Even if the expansion allowance portion 23E provided in the wavy inner fins 23A and 23B have reverse tapered surfaces 23G tapered towards the respective tips formed by the wall surfaces between the tips 23C and 23D in this manner, it is possible to deform in the vertical direction the reverse tapered surfaces 23G tapered towards the tips 23C and 23D by pressure applied to the inside of the tubes when expanding them, and therefore to increase the distance between the tips 23C and 23D. Thus, it is possible to expand the flat heat exchange tubes 14 with ease despite the fact that the wavy inner fins 23A and 23B in the flat heat exchange tubes 14 are soldered to the pair of molded plates 22A and 22B.

### Third Embodiment

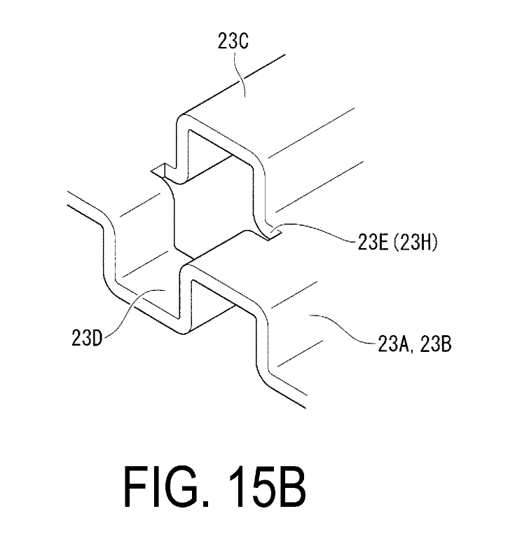

A third embodiment of the present invention will be described below, using FIGS. 15A and 15B.

The present embodiment differs from the first embodiment and the second embodiment in terms of the configuration of tips 23C and 23D and the expansion allowance portion 23E provided in the wavy inner fins 23A and 23B. Other points are the similar to the first and second embodiments, so their descriptions are omitted here.

In the present embodiment, as illustrated in FIGS. 15A and 15B, a configuration is adopted such that a plurality of tips 23C protruding to the one side and a plurality of tips 23D protruding to the other side of the wavy inner fins 23A and 23B are arranged alternately and continuously along the width direction of the fins, and alternately and at a prescribed interval along the length direction. The expansion allowance portion 23E has a configuration in which the wall surfaces at the base portions of the respective tips 23C and 23D have slits 23H formed therein.

Even with such a configuration, when expanding the tubes, the plurality of tips 23C and 23D arranged alternately in the width direction and length direction of the fins are deformed vertically by pressure applied therein through the expansion allowance portion 23E constituted of the slits 23H provided in the base portions of the tips 23C and 23D, thereby allowing the distance therebetween to be increased. Thus, it is possible to expand the flat heat exchange tubes 14 with ease despite the fact that the wavy inner fins 23A and 23B of the flat heat exchange tubes 14 are soldered to the pair of molded plates 22A and 22B.

Note that the present invention is not limited to the invention according to the embodiment as described above, and changes can be made as appropriate without departing from the gist thereof. For example, in the embodiments above, four layers of flat heat exchange tubes 14 are provided and PTC heaters 18 are inserted therebetween, but the number of flat heat exchange tubes 14 may naturally be three or less, or five or more.

Also, in the embodiments above, the flat heat exchange tubes 14 have a single-header structure with a U-turn path 21, but a double-header structure may be adopted for the flat heat exchange tubes 14, and furthermore, the shapes of the tips 23C and 23D of the wavy inner fins 23A and 23B inserted in the flat heat exchange tubes 14 can be various shapes such as trapezoidal, mountain-shaped, or semi-circular.

### REFERENCE SIGNS LIST

1 Heat carrier-heating device
14 Flat heat exchange tube
18 PTC heater
22 Flat tube
22A, 22B Molded plate
22C, 22D Vertical wall
22E Tube expansion allowance portion
22F Stepwise bend
23A, 23B Wavy inner fin
23C, 23D Tip
23E Expansion allowance portion
23F Stepwise bend
23G Reverse-tapered surface
23H Slit

1. A flat heat exchange tube comprising:
a flat tube configured by soldering together an opposing pair of molded plates formed from sheet materials having inner surfaces clad in solder; and
wavy inner fins inserted between the molded plates of the flat tube, the wavy inner fins each having a tip protruding in one direction that is soldered to the inner surface of one of the molded plates, and a tip protruding in another direction that is soldered to the inner surface of another of the molded plates,
the wavy inner fins each including an expansion allowance portion on a wall surface between the tip protruding in the one direction and the tip protruding in the other direction, the expansion allowance portions allowing deformation in a direction by which a distance between the tips increases, the flat tube being expandable through the expansion allowance portion in a state in which the tips are soldered to the pair of molded plates.

2. The flat heat exchange tube according to claim 1, wherein the expansion allowance portion is configured as stepwise bends formed in the wall surface between the tip protruding in the one direction and the tip protruding in the other direction.

3. The flat heat exchange tube according to claim 1, wherein the expansion allowance portion is a reverse-tapered surface that is tapered towards the respective tips, the reverse-tapered surface being formed of the wall surface between the tip protruding in the one direction and the tip protruding in the other direction.

4. The flat heat exchange tube according to claim 1, wherein the expansion allowance portion is configured such that the tip protruding in the one direction and the tip protruding in the other direction are arranged alternately and continuously in a width direction of the wavy inner fin, and alternately and at a prescribed interval in a length direction of the wavy inner fin, with slits being provided in the wall surface at a base portion of the tips.

5. The flat heat exchange tube according to claim 1, wherein the pair of molded plates include tube expansion allowance portions in vertical walls thereof from soldered portions of edges of the pair of molded plates, the tube expansion allowance portion allowing deformation in a direction by which a distance between flat surfaces of the molded plates increases.

6. A heat carrier-heating device, wherein a plurality of groups of PTC heaters are layered alternately between a plurality of flat heat exchange tubes, a heat carrier flowing through the flat heat exchange tubes being heated by control of electricity flowing to the PTC heaters, and
wherein the flat heat exchange tubes are the flat heat exchange tubes described in claim 1, the PTC heaters and the flat heat exchange tubes being in close contact with each other by the flat heat exchange tubes being expanded while the PTC heaters are layered alternately between the plurality of flat heat exchange tubes.

7. An air conditioner for a vehicle configured such that a heat carrier heated by a heat carrier-heating device can circulate to a heat radiator disposed in an airflow path,
wherein the heat carrier-heating device is the heat carrier-heating device described in claim 6.

8. The flat heat exchange tube according to claim 2, wherein the pair of molded plates include tube expansion allowance portions in vertical walls thereof from soldered portions of edges of the pair of molded plates, the tube expansion allowance portion allowing deformation in a direction by which a distance between flat surfaces of the molded plates increases.

9. The flat heat exchange tube according to claim 3, wherein the pair of molded plates include tube expansion allowance portions in vertical walls thereof from soldered portions of edges of the pair of molded plates, the tube expansion allowance portion allowing deformation in a direction by which a distance between flat surfaces of the molded plates increases.

10. The flat heat exchange tube according to claim 4, wherein the pair of molded plates include tube expansion allowance portions in vertical walls thereof from soldered portions of edges of the pair of molded plates, the tube expansion allowance portion allowing deformation in a direction by which a distance between flat surfaces of the molded plates increases.

11. A heat carrier-heating device, wherein a plurality of groups of PTC heaters are layered alternately between a plurality of flat heat exchange tubes, a heat carrier flowing through the flat heat exchange tubes being heated by control of electricity flowing to the PTC heaters, and
wherein the flat heat exchange tubes are the flat heat exchange tubes described in claim 2, the PTC heaters and the flat heat exchange tubes being in close contact with each other by the flat heat exchange tubes being expanded while the PTC heaters are layered alternately between the plurality of flat heat exchange tubes.

12. A heat carrier-heating device, wherein a plurality of groups of PTC heaters are layered alternately between a plurality of flat heat exchange tubes, a heat carrier flowing through the flat heat exchange tubes being heated by control of electricity flowing to the PTC heaters, and
wherein the flat heat exchange tubes are the flat heat exchange tubes described in claim 3, the PTC heaters and the flat heat exchange tubes being in close contact with each other by the flat heat exchange tubes being expanded while the PTC heaters are layered alternately between the plurality of flat heat exchange tubes.

13. A heat carrier-heating device, wherein a plurality of groups of PTC heaters are layered alternately between a plurality of flat heat exchange tubes, a heat carrier flowing through the flat heat exchange tubes being heated by control of electricity flowing to the PTC heaters, and
wherein the flat heat exchange tubes are the flat heat exchange tubes described in claim 4, the PTC heaters and the flat heat exchange tubes being in close contact with each other by the flat heat exchange tubes being expanded while the PTC heaters are layered alternately between the plurality of flat heat exchange tubes.

14. A heat carrier-heating device, wherein a plurality of groups of PTC heaters are layered alternately between a plurality of flat heat exchange tubes, a heat carrier flowing through the flat heat exchange tubes being heated by control of electricity flowing to the PTC heaters, and
wherein the flat heat exchange tubes are the flat heat exchange tubes described in claim 5, the PTC heaters and the flat heat exchange tubes being in close contact with each other by the flat heat exchange tubes being expanded while the PTC heaters are layered alternately between the plurality of flat heat exchange tubes.
